(19) United States
(12) Patent Application Publication
(10) Pub. No.: US 2007/0139670 A1
(43) Pub. Date: Jun. 21, 2007

(54) Color image edge enhancement method

(76) Inventor: Wen-Ning Kuo, Taipei (TW)

Correspondence Address: HARNESS, DICKEY & PIERCE, P.L.C., P.O. BOX 8910, RESTON, VA, 20195, US

(21) Appl. No.: 11/312,573

(22) Filed: Dec. 21, 2005

(51) Int. Cl. G06F 15/00; H04N 1/46

(52) U.S. Cl. 358/1.9; 358/534

(57) ABSTRACT

A color image edge enhancement method having the following steps: Firstly, divide a color image into four color planes with the Cyan, Magenta, Yellow, and Black color (CMYK) respectively. Next, implement the halftone processing of the four respective color planes, thus generate four halftone images of the four CYMK colors. Then, compare the dotting patterns of the edge pixels to be enhanced and the pixels in its perimeter in the halftone images of the respective color planes with the patterns in an edge enhancement table, to search and obtain a dotting table and its corresponding dotting command having the most matching pattern. Finally, compare the dotting table and the corresponding dotting command having the most matching patterns with the contents of a dotting command corresponding table, to search and obtain the actual dotting command, and then execute the actual dotting commands thus obtained in dotting the edge pixel.

### BACKGROUND

1. Field of the Invention

The invention relates to an image edge enhancement method applied to a grid matrix output device, and in particular to a color image edge enhancement method, which is used to determine how to proceed with the dotting of the edge pixels of the color images, so that the edges of the output images can be made smoother.

2. Related Art

Recently, in the field of image processing, the key point of most research and development is to improve the visual effect of an image output apparatus (e.g. a printer) such that the visual effect generated after image output matches with the real subject. The edge of the original image object, e.g., texts, curves, three-dimensional objects, etc., can be approximated by the linear equation or natural logarithm, etc., to be more smooth. When these objects are digitally processed, they are required to be converted into a matrix form which is processable for an image output apparatus, and their edges are required to match the grids of the apparatus.

However, if the resolution of the image output apparatus is relatively low, the edge of the image object is found to be step-shaped of one grid by another grid through the naked eye, and a smooth edge as that of the original image object cannot be obtained. Therefore, various solutions are proposed to reduce the jagged effect on the edge of the image object, such that the image output by the image output apparatus can match with the real subject.

As for Edge Enhancement Method and Apparatus for Dot Matrix Devices disclosed in U.S. Pat. No. 5,029,108, the dotting state of the pixels of an image edge and that of the surrounding pixels are compared with a plurality of predetermined pictures, to determine which predetermined picture the pixels of the image edge match with, thus it is determined how to dot the pixels at the image edge to smooth the output image edge and to allow the image more accurately match with the original one. The enhancement of central pixels of each predetermined picture will be modified differently according to the dotting state of the surrounded pixels, for example, dotting at ¼ to the left of the central pixel, dotting at ⅔ to the right of the central pixels, etc

However, the method mentioned above is only suitable for single color image output (namely, the black and white image output). When executing the color image output of the image output device, since each of the color images are composed of the planes of four different colors (cyan, magenta, yellow, and black; CMYK), Thus, in executing the supplementary dotting of the pixels on the edge of the image, the planes of all the four colors must be taken into consideration. Presently it doesn't have any mechanism, which can be utilized to determine the planes, of which colors must be utilized to implement the supplementary dotting of the pixels on the edge of the image. However, if the planes of all the four colors are used to perform the supplementary dotting, then the color displayed on this pixel will be black, thus it may be different from that of the original subject. Nevertheless, there is just no way to know which color may be used to implement the supplementary dotting.

Therefore, to the color image output device, the determination of how to enhance the edge of the image, so that the edge of the output image is smoother and with its color matching that of the original subject, is the most important problem that must be solved in this field.

### SUMMARY OF THE INVENTION

In view of the above-mentioned problems and shortcomings of the prior art, the object of the invention is to provide a color image edge enhancement method, which is applied to a grid matrix output device such as a printer or display. The color image edge enhancement method is used to determine which color planes are to be used and how to proceed with the dotting of the pixels on the edge of a color image, so that the color of the produced image matches that of the original subject, thus the edge of the image can be made smoother, without generating jagged edges.

Therefore, to achieve the above-mentioned object, the color image edge enhancement method of the invention includes the following steps:

Firstly, divide a color image into four color planes with four different colors corresponding CMYK colors. Next, implement the halftone processing of the respective color planes, thus generate four halftone images corresponding CYMK colors.

Then, compare an edge pixel to be enhanced and its perimeter pixels in each halftone image with the contents of an edge enhancement table, to search and obtain the matching dotting table corresponding to the dotting command.

This edge enhancement table is calculated and structured according to the equations as disclosed in the above-mentioned U.S. Pat. No. 5,029,108. There have seven groups of dotting tables corresponding different dotting commands. These dotting commands are utilized to determine how a central pixel to be dotted according to their dotting pattern of the central pixel and its perimeter pixels at a grid table on the halftone image (this central pixel corresponds the edge pixel of the image to be dotted and enhanced).

In the above-mentioned process, each color plane is possible to find the dotting table having the matching dotting patterns, or can't find the dotting table having the matching dotting patterns.

Finally, compare the dotting table and the dotting command of the most matching pattern of each color plane with the contents of a dotting command corresponding table, to search and obtain the actual dotting commands in dotting the edge pixel.

The dotting command corresponding table indicates the comparison result of the dotting commands corresponding the respective color planes, and how to implement the dotting by making use of the respective color planes, when no color plane finds its most matching dotting commands, one color plane finds its most matching dotting command, two color planes find their most matching dotting commands, three color planes find their most matching dotting commands, and all of color planes find their most matching dotting commands.

As such, the dotting of the edge pixel can be realized by making use of the actual compared dotting commands, and obtained from the dotting command corresponding table, so that the color of the produced color image is more compatible with that of the original subject, and the edge of the image is made smoother, without generating jagged edges.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing will be provided by the Office upon request and payment of the necessary fee.

The invention will become more fully understood from the detailed description given below, which is for illustration only and thus is not limitative of the invention.

FIG. 1 shows a color image indicating an edge pixel A;

FIG. 2 is a system flowchart illustrating the various steps of the edge enhancement method for color images according to an embodiment of the invention;

FIGS. 3A to 3D are four color planes corresponding CMYK colors by dividing the image of the edge pixel shown in FIG. 1;

FIGS. 4A to 4D show the halftone images of the four color planes obtained through halftone processing of the images of FIGS. 3A to 3D; and

FIGS. 5A to 5I show the schematic diagrams of the respective edge enhancement tables.

### DETAILED DESCRIPTION OF THE INVENTION

The purpose, construction, features, and functions of the invention can be appreciated and understood more thoroughly through the following detailed description with reference to the attached drawings.

The invention provides a color image edge enhancement method, which is applied to a grid matrix output device such as a printer or display. The color image edge enhancement method is used to determine which color planes are to be used and how to proceed with the dotting of the pixels on the edge of a color image, so that the color of the produced image matches that of the original subject, thus the edge of the image can be made smoother, without generating jagged edges.

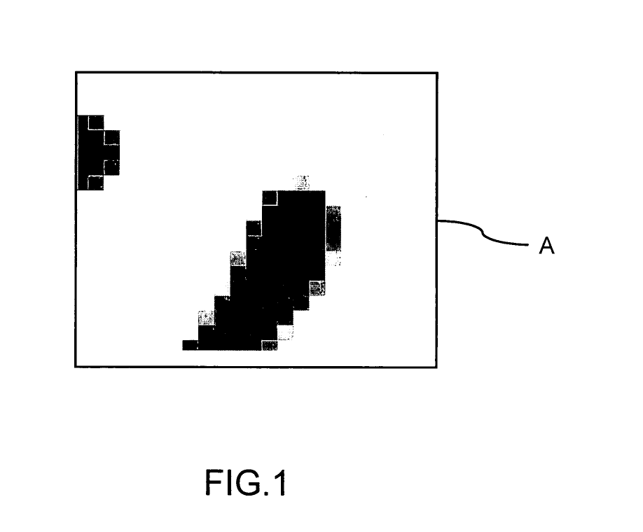

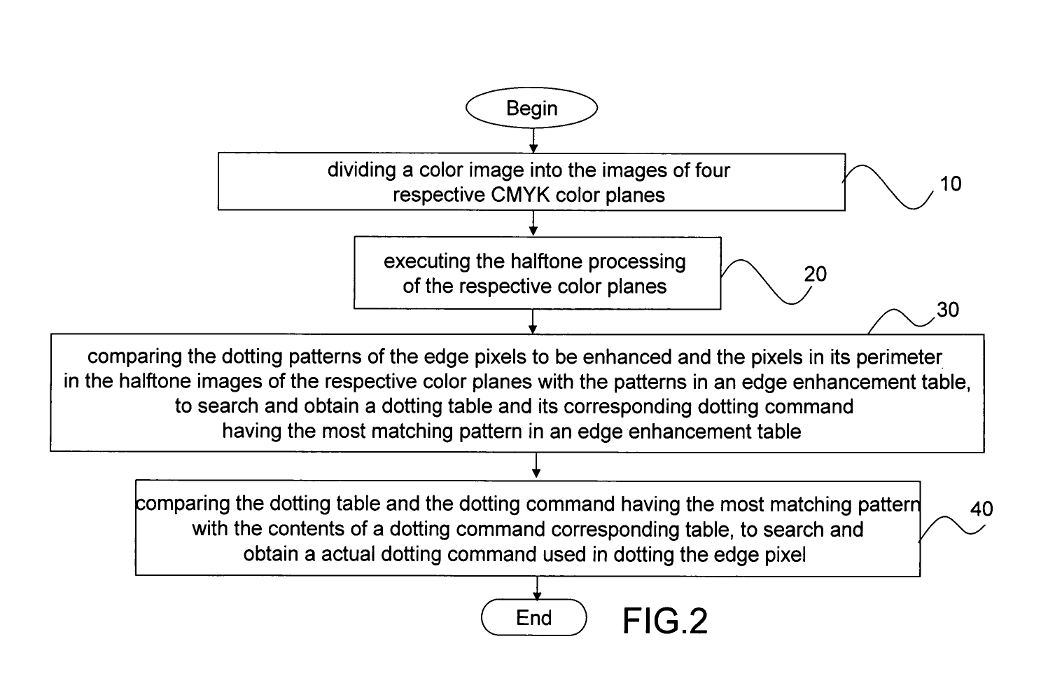

Refer to FIGS. 1A and 1B for a color image indicating an edge pixel A and an enlarged view of an edge pixel A in FIG. 1A. The edge pixel A is utilized to illustrate a method of enhancing the edge pixel according to an embodiment of the invention. Next, refer to FIG. 2, for a system flowchart illustrating the various steps of the color image edge enhancement method according to an embodiment of the invention. The details of each of the steps are described as follows.

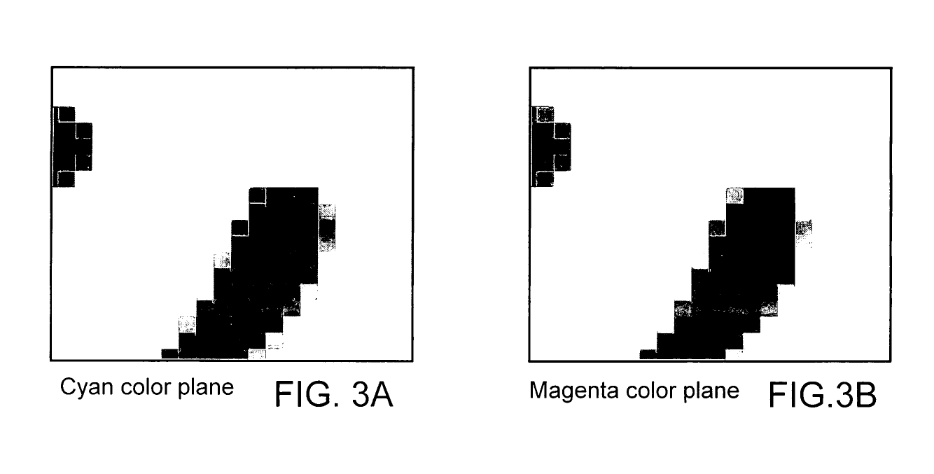

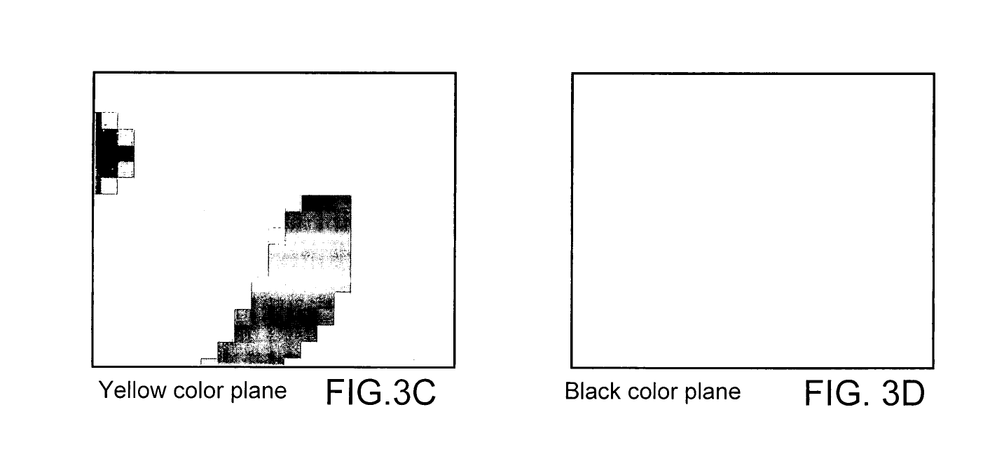

Firstly, divide a color image containing an edge pixel shown in FIG. 1 into four color planes with four different colors corresponding CMYK colors respectively (step 10). The four color planes with CMYK color after division are shown in FIGS. 3A to 3D respectively.

Next, implement the halftone processing to each color plane (step 20), thus generate four halftone images corresponding the CYMK colors.

Then, compare the dotting pattern of an edge pixel to be enhanced and its perimeter pixels in each halftone image with the contents of an edge enhancement table, to search and obtain the matching dotting table corresponding to the dotting command (step 30).

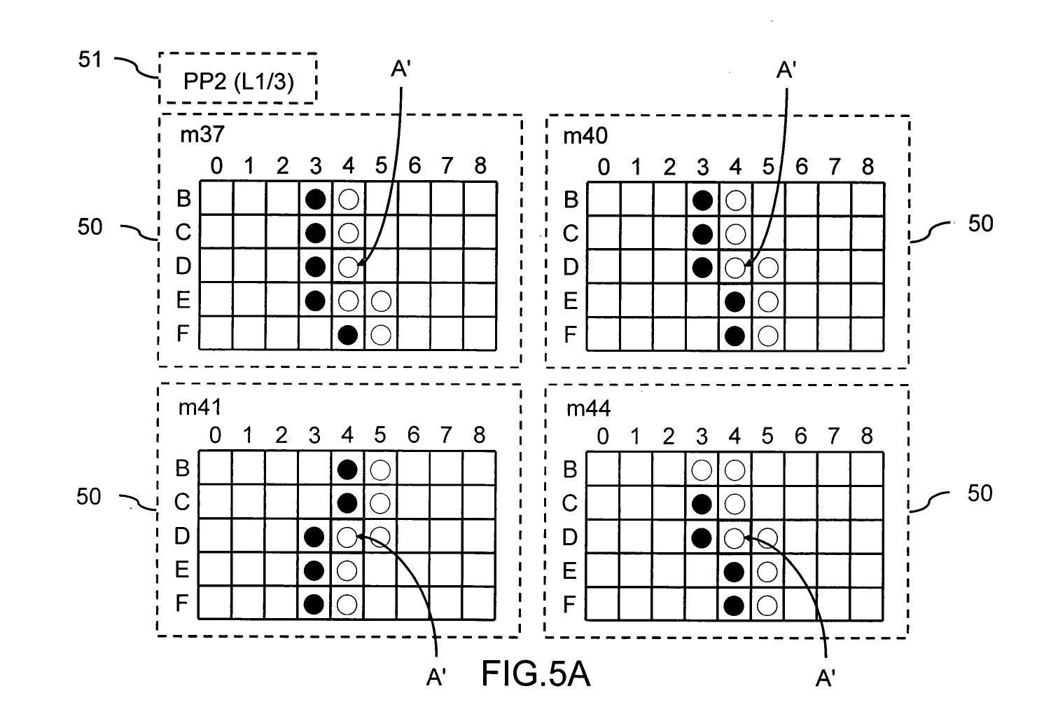

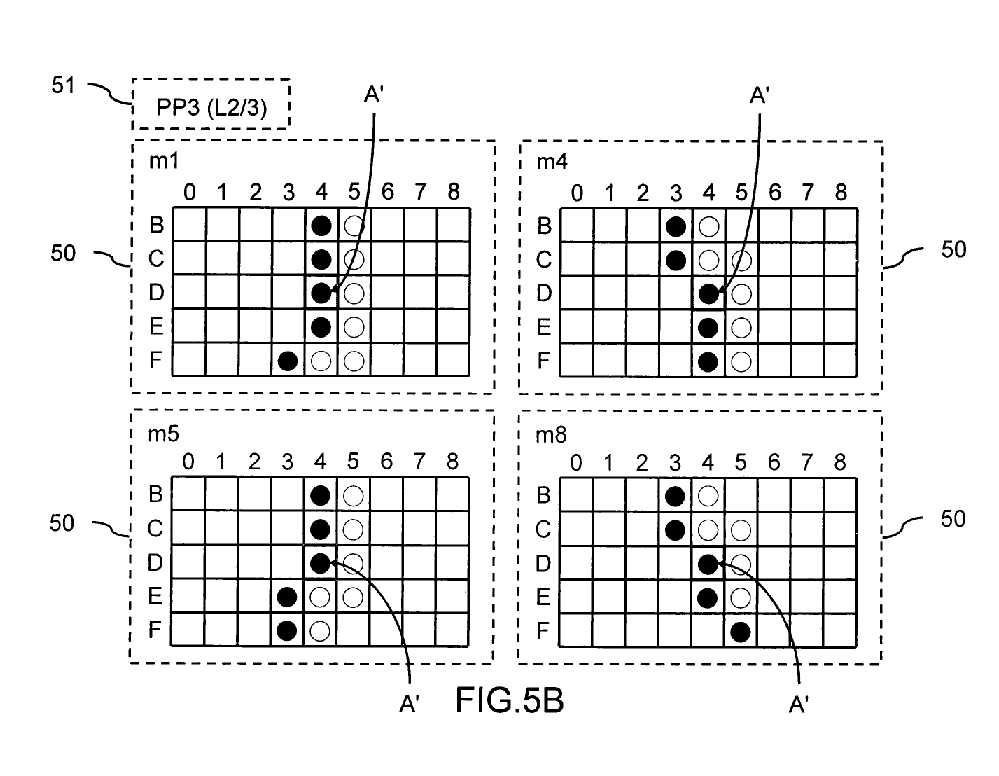

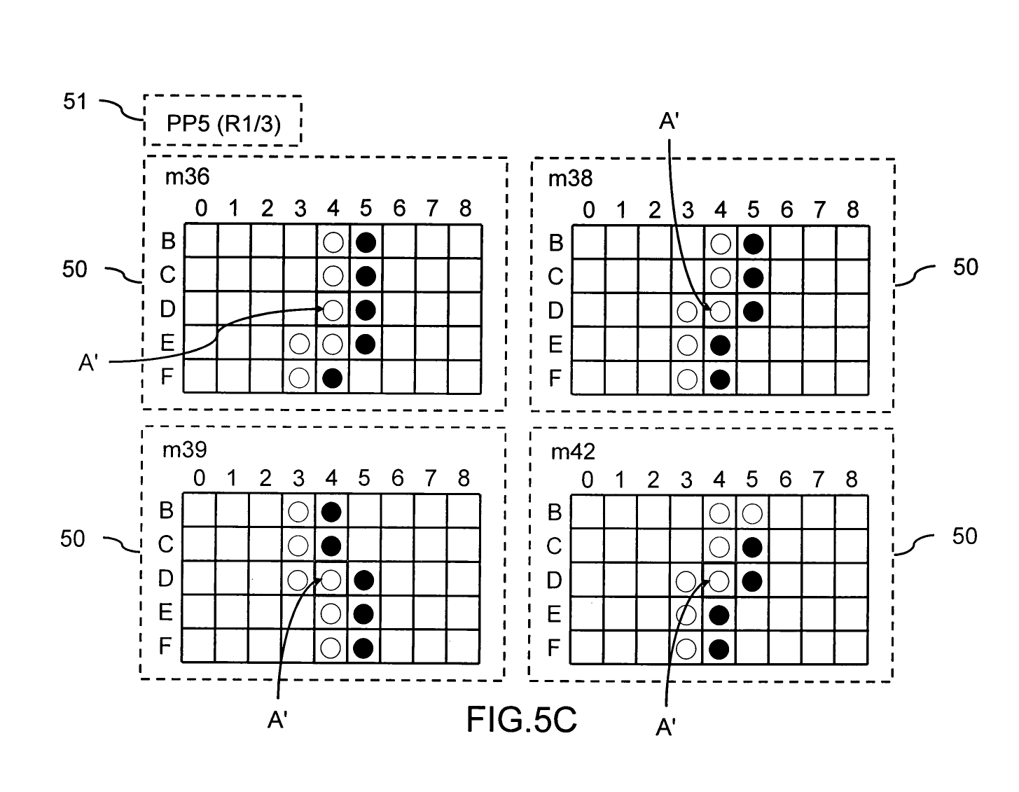

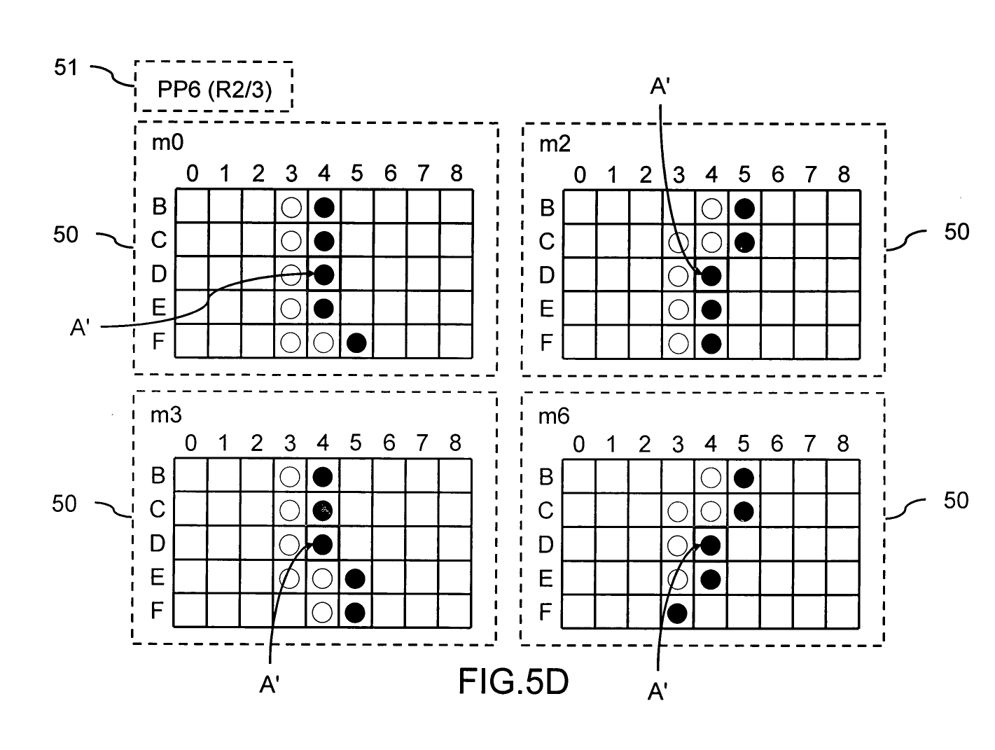

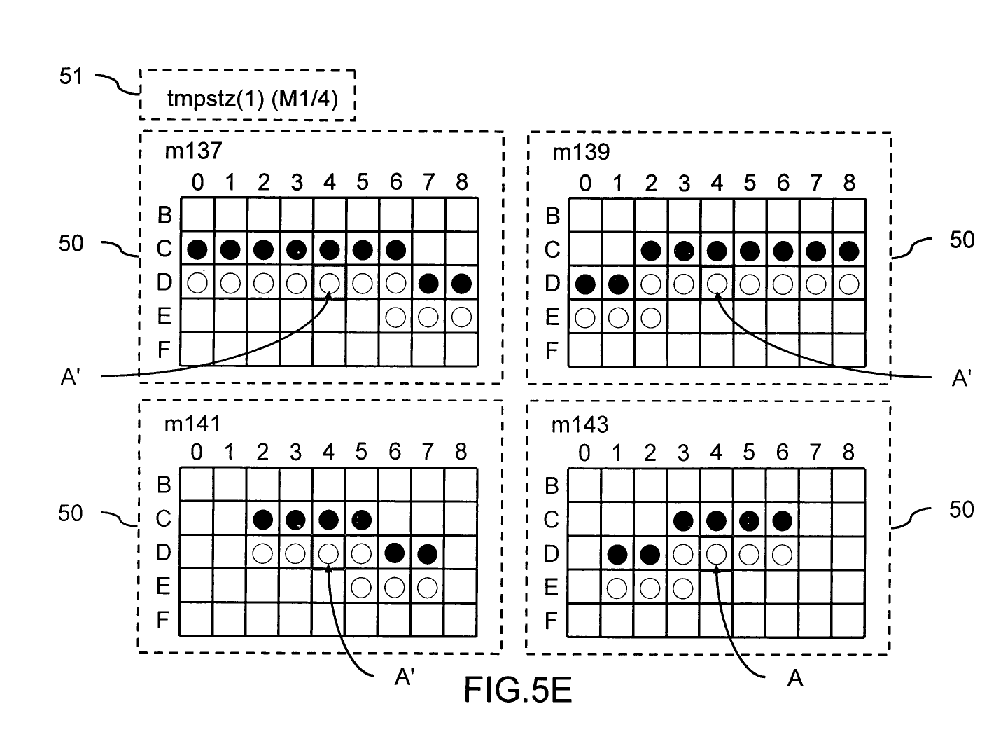

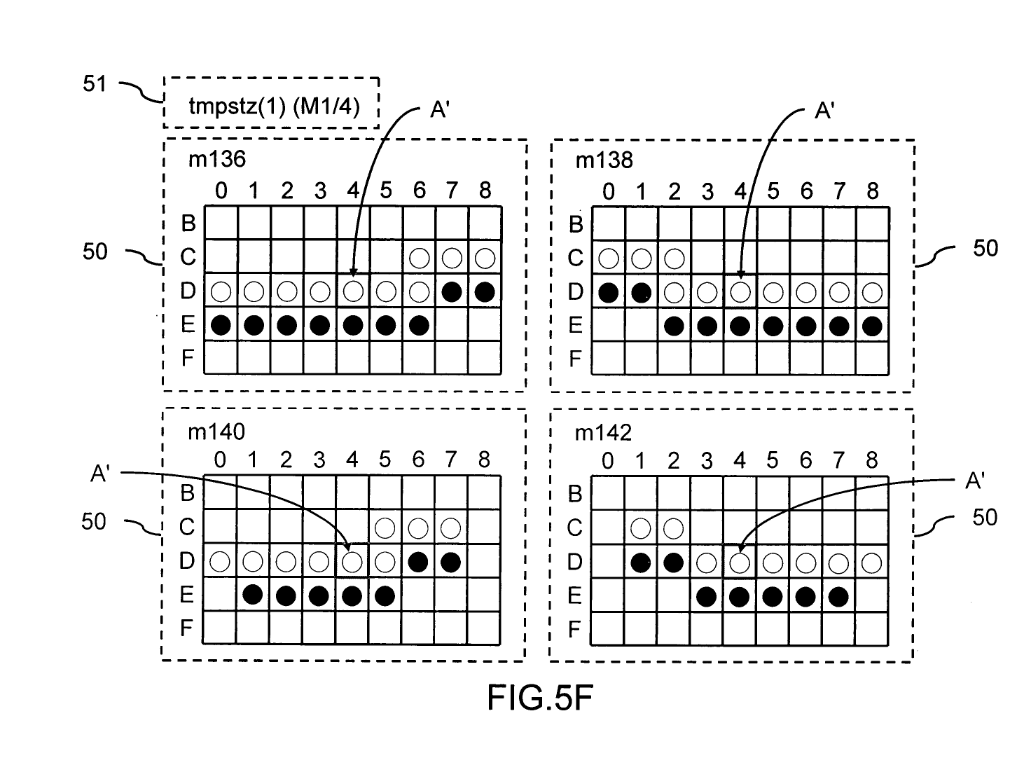

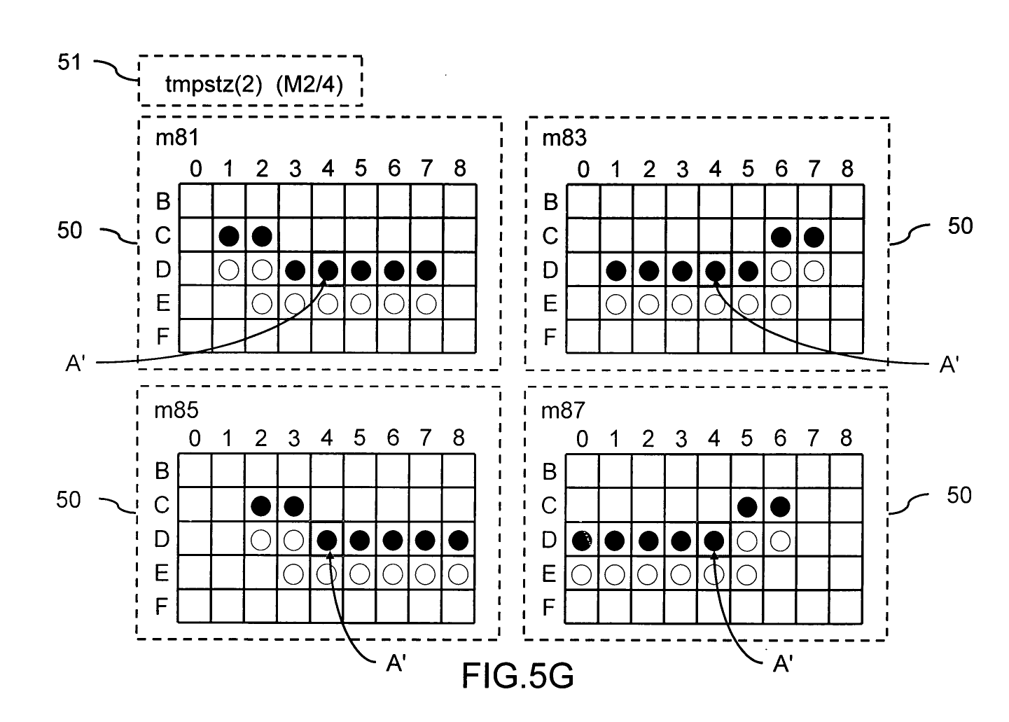

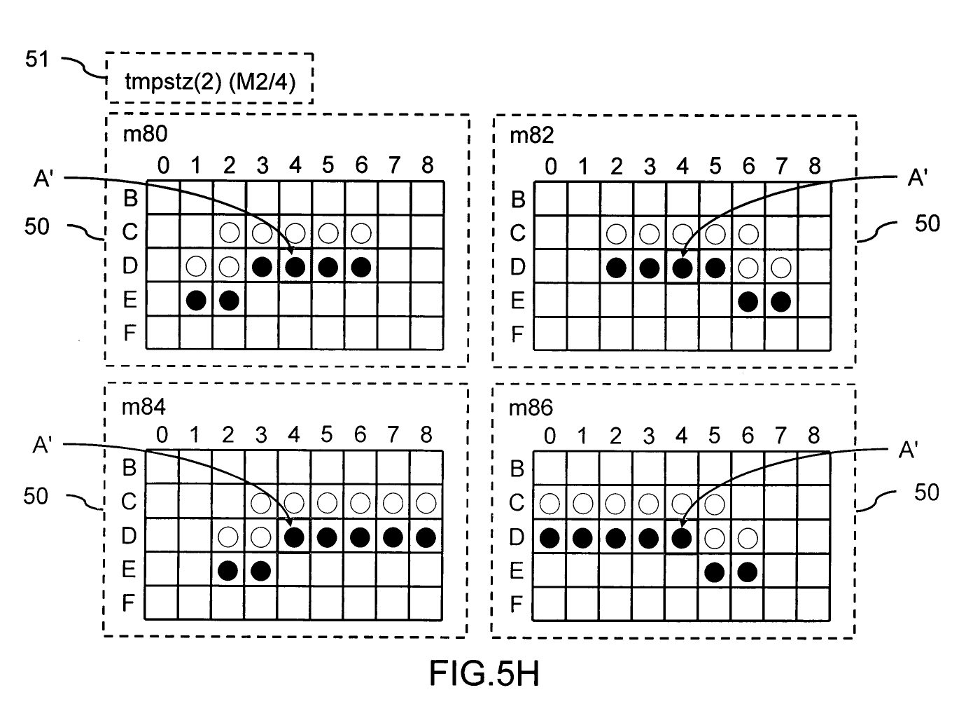

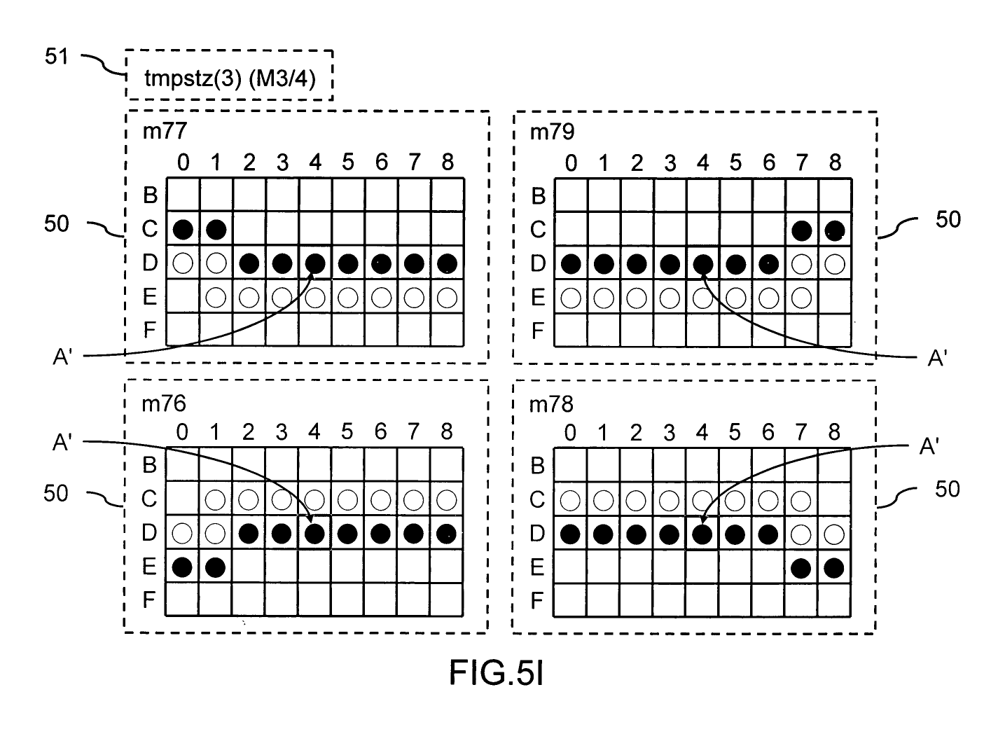

Subsequently, refer to FIGS. 5A to 5I for the schematic diagram of the edge enhancement table. In the embodiment of the invention, there have seven groups of dotting tables 50 corresponding different dotting commands 51. Each dotting table 50 constructs as a 9×5 grid table. These dotting commands 51 are utilized to determine how the central pixel A′ to be dotted according to their dotting pattern of the central pixel A′ and its perimeter pixels on the halftone image (this central pixel A′ corresponds the edge pixel A of FIGS. 1A and 1B.).

In the above descriptions, each group of dotting tables 50 correspond the same dotting commands 51. In the edge enhancement table of this embodiment, each group only consists of 2 to 4 dotting tables 50 as an example. However, each of the respective dotting commands 51 may have more dotting tables 50, which can be utilized as a basis in dotting the central pixel A′ of different patterns.

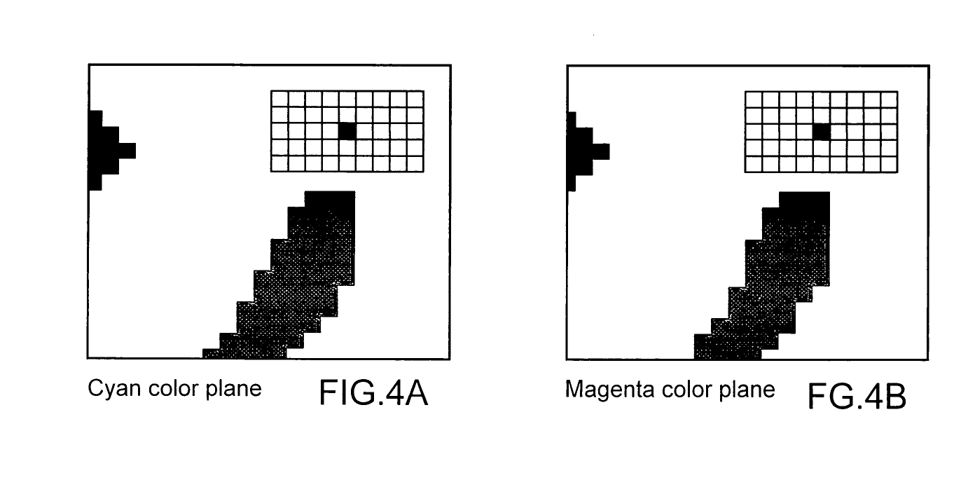

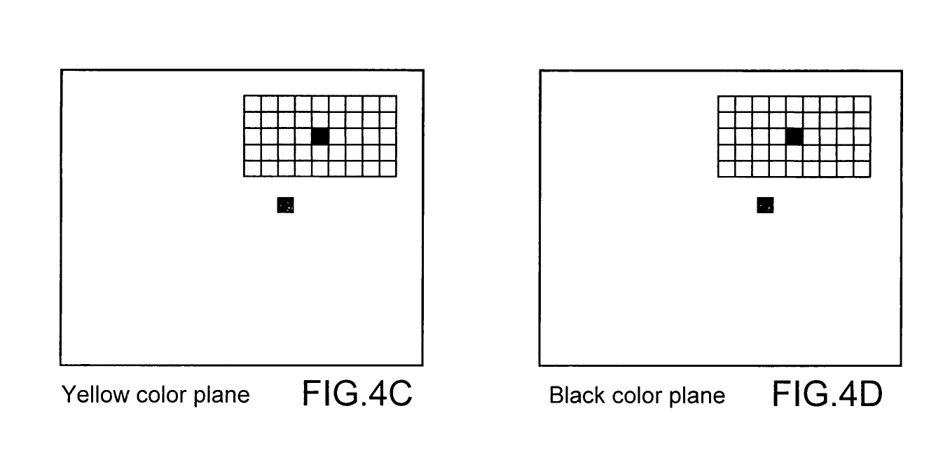

In this step, the dotting patterns of the edge pixel A and the pixels in its perimeter, as shown in each of the respective halftone images of FIGS. 4A to 4D, are compared with the patterns in FIGS. 5A to 5I of the edge enhancement table, to search and obtain the dotting table 50 and its corresponding dotting command 51.

To the halftone image of Cyan color plane as shown in FIG. 4A, its dotting pattern of edge pixel A and the pixels in its perimeter match closely to the dotting table 50 of number mm44 of group PP2 of the edge enhancement table dotting table 50. Thus, the dotting command 51 corresponding the dotting table 50 of number mm44 indicates that the dotting of the central pixel enhancement is performed at the left ⅓ position of the central pixel A′, so that its edge can be made smoother. Moreover, to the halftone image of the Magenta color plane as shown in FIG. 4B, the dotting pattern of edge pixel A and the pixels in its perimeter matches none of the patterns in all of the dotting tables 50 of the edge enhancement table. Similarly, to the halftone image of Yellow and Black color planes shown in FIGS. 4C and 4D, their respective dotting patterns of edge pixel A and the pixels in its perimeter match none of the patterns in all of the dotting tables 50 of the edge enhancement table also.

Upon comparing and obtaining the dotting table 50 and its corresponding dotting command 51 having the most matching patterns corresponding the half-toned images of the various color planes (step 30), compare the dotting table and dotting command of the most matching patterns with the contents of a dotting command corresponding table, thus searching and obtaining the actual dotting commands utilized in performing the enhancement dotting of the edge pixel (step 40).

Refer to tables 1-1, 1-2, 1-3, and 1-4 for the dotting command corresponding tables, which can be utilized in determining how to proceed with the enhancement dotting of the edge pixel in the following manners. Table 1-1 indicates how to implement the dotting of the edge pixel when no color plane finds its most matching dotting commands, and when one color plane finds its most matching dotting command Table 1-2, indicates how to implement the dotting of the edge pixel when two color planes find their most matching dotting commands. Table 1-3 indicates how to implement the dotting of the edge pixel when three color planes find their most matching dotting commands. And finally, table 1-4 indicates how to implement the dotting of the edge pixel when all of the color planes find their most matching dotting commands.

TABLE 1-1
Dotting command corresponding table

| | |
|---|---|
| comparison results | actual dotting commands |

| | | |
|---|---|---|
| match color plane | none | keep original result |
| match color plane | one color plane | dotting commands: the |
| | | matching color plane |

TABLE 1-2
Dotting command corresponding table

| comparison results | | | actual dotting commands |
|---|---|---|---|
| match color | C | M | |
| plane | | | |
| dotting | left ⅓ | right ⅓ | C: left ⅓ and M: right ⅓ |
| commands | left ⅓ | left ⅓ | C: left ⅓ or M: left ⅓ |
| | right ⅓ | right ⅓ | C: right ⅓ or M: right ⅓ |
| | . . . | . . . | . . . |
| match color | C | Y | |
| plane | | | |
| dotting | left ⅓ | right ⅓ | C: left ⅓ and Y: right ⅓ |
| commands | left ⅓ | left ⅓ | C: left ⅓ or Y: left ⅓ |
| | right ⅓ | right ⅓ | C: right ⅓ or Y: right ⅓ |
| | . . . | . . . | . . . |
| match color | C | K | |
| plane | | | |
| dotting | left ⅓ | right ⅓ | C: left ⅓ & K: right ⅓ |
| commands | left ⅓ | left ⅓ | K: left ⅓ |
| | right ⅓ | right ⅓ | K: right ⅓ |
| | . . . | . . . | . . . |
| match color | M | Y | |
| plane | | | |
| dotting | left ⅓ | right ⅓ | M: left ⅓ & Y: right ⅓ |
| commands | left ⅓ | left ⅓ | M: left ⅓ or Y: left ⅓ |
| | right ⅓ | right ⅓ | M: right ⅓ or Y: right ⅓ |
| | . . . | . . . | . . . |
| match color | M | K | |
| plane | | | |
| | left ⅓ | right ⅓ | M: left ⅓ & K: right ⅓ |
| dotting | left ⅓ | left ⅓ | K: left ⅓ |
| commands | right ⅓ | right ⅓ | K: right ⅓ |
| | . . . | . . . | . . . |

TABLE 1-3
Dotting command corresponding table

| comparison results | | | | actual dotting commands |
|---|---|---|---|---|
| match | C | M | Y | |
| color plane | | | | |
| dotting | left ⅓ | left ⅓ | left ⅓ | C: left ⅓ or M: left |
| commands | | | | ⅓ or Y: left ⅓ |
| | left ⅓ | left ⅓ | right ⅓ | C: left ⅓ or M: left |
| | | | | ⅓ or Y: right ⅓ |
| | left ⅓ | right ⅓ | left ⅓ | C: left ⅓ or M: right |
| | | | | ⅓ or Y: left ⅓ |
| | . . . | . . . | . . . | . . . |
| match | C | M | K | |
| color plane | | | | |
| dotting | left ⅓ | left ⅓ | left ⅓ | K: left ⅓ |
| commands | left ⅓ | left ⅓ | right ⅓ | C: left ⅓ or M: left |
| | | | | ⅓ or K: right ⅓ |
| | left ⅓ | right ⅓ | left ⅓ | K: left ⅓ or M: right |
| | | | | ⅓ |
| | . . . | . . . | . . . | . . . |
| match | C | K | Y | |
| color plane | | | | |
| dotting | left ⅓ | left ⅓ | left ⅓ | K: left ⅓ |
| commands | left ⅓ | left ⅓ | right ⅓ | K: left ⅓ and Y: right |
| | | | | ⅓ |
| | left ⅓ | right ⅓ | left ⅓ | C: left ⅓ or Y: left |
| | | | | ⅓ and K: right ⅓ |
| | . . . | . . . | . . . | . . . |
| match | M | K | Y | |
| color | | | | |
| plane | | | | |
| dotting | left ⅓ | left ⅓ | left ⅓ | K: left ⅓ |
| commands | left ⅓ | left ⅓ | right ⅓ | K: left ⅓ or Y: right |
| | | | | ⅓ |
| | left ⅓ | right ⅓ | left ⅓ | M: left ⅓ or Y: left |
| | | | | ⅓ or K: right ⅓ |
| | . . . | . . . | . . . | . . . |

TABLE 1-4
Dotting command corresponding table

| comparison results | | | | | actual dotting commands |
|---|---|---|---|---|---|
| match | C | M | Y | K | |
| color plane | | | | | |
| dotting | left | left | Left | left | K: left ⅓ |
| commands | ⅓ | ⅓ | ⅓ | ⅓ | |
| | left | left | left | right | K: right ⅓ and C: left |
| | ⅓ | ⅓ | ⅓ | ⅓ | ⅓ or M: left ⅓ or Y |
| | | | | | left ⅓ |
| | left | left | right | left | K: left ⅓ and Y: right |
| | ⅓ | ⅓ | ⅓ | ⅓ | ⅓ |
| | left | left | right | right | K: right ⅓ and C: left |
| | ⅓ | ⅓ | ⅓ | ⅓ | ⅓ or M: left ⅓ |
| | left | right | left | left | K: left ⅓ and M: right |
| | ⅓ | ⅓ | ⅓ | ⅓ | ⅓ |
| | left | right | left | right | K: right ⅓ and C: left |
| | ⅓ | ⅓ | ⅓ | l/3 | ⅓ or Y: left ⅓ |
| | left | right | right | left | K: left ⅓ and M: right |
| | ⅓ | ⅓ | ⅓ | ⅓ | ⅓ or Y: right ⅓ |
| | . . . | . . . | . . . | . . . | . . . |

By way of example, if it is known from step 30 that the dotting command for the cyan color plane is: dotting at the left ⅓ position of the edge pixel, and the dotting command for the magenta color plane is: dotting at the right ⅓ position of the edge pixel, then the corresponding actual dotting command obtained from the dotting command corresponding table 1-2 is: dotting at the left ⅓ position of the edge pixel by making use of the cyan color plane and dotting at the right ⅓ position of the edge pixel by making use of the magenta color plane.

However, if it is known from step 30 that the pattern of the halftone image of cyan color plane can only find its matching pattern in the number m44 dotting table 50, then the corresponding dotting command 51 is: dotting at the left ⅓ position of the edge pixel A′. However, the color planes of other colors search, but can not find any corresponding dotting tables having the most matching pattern. Thus from table 1-1 it is known that the corresponding actual dotting command is: dotting at the left ⅓ position of the edge pixel A′ by making use of a Cyan color plane. As such, the color of the edge of the image thus produced is more compatible with that of the original subject, and the edge of the image is thus smoother, without generating jagged edges.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A color image edge enhancement method, comprising the following steps:
dividing a color image into the images of four respective cyan, magenta, yellow, and black (CMYK) color planes;
implementing the halftone processing of the respective color planes to obtain a plurality of halftoned images;
comparing the dotting patterns of the edge pixels to be enhanced and the pixels in its perimeter in the halftone images of the respective color planes with the patterns in an edge enhancement table, to search and obtain a dotting table and its corresponding dotting command having the most matching pattern in an edge enhancement table; and
comparing the dotting table and the dotting command having the most matching pattern with the contents of a dotting command corresponding table, to search and obtain a actual dotting command used in dotting the edge pixel.

2. The color image edge enhancement method as claimed in claim 1, wherein the edge enhancement table is provided with more than one dotting tables, the respective dotting tables correspond to the various different dotting commands according to the patterns of its central pixel and the pixels in its perimeter.

3. The color image edge enhancement method as claimed in claim 1, wherein the dotting command corresponding table is provided with: the items of the respective color planes having the most matching patterns, the various combinations of the respective dotting commands and the corresponding actual dotting command.

4. The color image edge enhancement method as claimed in claim 1, wherein the dotting command includes the dotting positions of the edge pixel to be enhanced.

5. The color image edge enhancement method as claimed in claim 1, wherein the dotting table is a 9 by 5 grid table.
